(19) United States
(12) Patent Application Publication
(10) Pub. No.: US 2026/0307324 A1
(43) Pub. Date: Oct. 8, 2026

(54) MELT-OUT MANDREL FOR COMPOSITE STRUCTURES

(71) Applicant: Kingdom First Holdings, Inc., Wichita, KS (US)

(72) Inventor: Darrin Teeter, Wichita, KS (US)

(21) Appl. No.: 19/169,672

(22) Filed: Apr. 3, 2025

(51) Int. Cl. B29C 53/82; B29C 33/38

(52) U.S. Cl. CPC B29C 53/822; B29C 33/38

(57) ABSTRACT

A system and method of producing a melt-out mandrel for defining an inner geometry of a composite article. The method includes melting a compounded mandrel material to a flowable state and injecting the flowable-state, compounded mandrel material into a mold having a shape that defines the inner geometry of the composite article. The method also includes cooling the flowable-state, compounded mandrel material to a solidification temperature within the mold, thereby forming a solidified melt-out mandrel that is then removed from the mold. The method further includes wrapping composite material around the solidified melt-out mandrel and curing the composite material wrapped thereon into the composite article. The compounded mandrel material has a higher melting point than a curing point of the composite material. Additionally, the method includes melting the solidified melt-out mandrel for removal from the cured composite article.

### BACKGROUND OF THE INVENTION

Composite materials, particularly continuous fiber-reinforced composites, have become increasingly prevalent in high-performance applications where exceptional strength-to-weight ratios are required. Industries such as aerospace, marine, wind energy, and automotive have embraced composite structures to achieve weight reduction while improving structural integrity. However, manufacturing composite parts with complex internal geometries, often referred to as “trapped geometries,” presents significant challenges with conventional fabrication methods.

Traditional approaches to creating internal cavities or complex geometries within composite structures typically involved collapsible mandrels, dissolvable cores, or inflatable bladders. Each of these techniques present limitations in achieving high-rate manufacturing of composite structures. Collapsible mandrels require complex tooling design, assembly and disassembly. Seams and joints often present a problem of mark-off on the composite structure, and some internal geometries of composite structures are physically impossible to fabricate with collapsible mandrels. Dissolvable salt and sand cores have been used but are difficult to manufacture and remove from the composite structure. Additionally, environmental concerns arise from the disposal of dissolved materials. Inflatable bladders cannot precisely control complex internal geometries, once again limiting the design options for the internal structure of the composite article.

These limitations are particularly problematic in the production of high-performance propeller blades, aircraft wing spars, wind turbine components, and composite vessels where internal geometry directly impacts structural performance and weight distribution. Current manufacturing techniques often necessitate design compromises that balance manufacturability against ideal structural performance. Despite advances in composites manufacturing technology, the industry has lacked a comprehensive solution for creating complex internal geometries within trapped structures like propeller blades. As the demand for blades increase in high-volume applications like advanced air mobility, solutions for high-rate composites manufacturing are needed for complex, integrated composite structures.

### SUMMARY OF THE INVENTION

Embodiments of the current invention address one or more of the above-mentioned problems and provide a distinct advance in the art of producing complex internal geometries within composite structures.

Disclosed herein are methods and systems for producing hollow composite articles with the aid of a melt-out mandrel produced by a high-rate manufacturing process. The methods described are applicable to propeller blades and other types of complex composite articles used in aerospace, marine, wind energy, automotive, and other high-performance applications. In one aspect, a method of producing a melt-out mandrel for defining an inner geometry of a composite article includes melting a compounded mandrel material to a flowable state. The compounded mandrel material includes a compounded thermoplastic material. The flowable-state, compounded mandrel material is injected into a mold having a shape that defines the inner geometry of the composite article. The flowable-state, compounded mandrel material is cooled to a solidification temperature within the mold, thereby forming a solidified melt-out mandrel via the solidification of the compounded mandrel material. The solidified melt-out mandrel is removed from the mold.

In another aspect, a method of producing a melt-out mandrel for defining an inner geometry of a composite article includes preparing a compounded mandrel material by melting and compounding a compounded thermoplastic material with an extruder until the compounded mandrel material is in a flowable state. The flowable-state, compounded mandrel material is fed from the extruder directly into an injection unit of an injection molding machine. The flowable-state, compounded mandrel material is injected into a mold to form said flowable-state, compounded mandrel material into a shape that defines the inner geometry of the composite article. The flowable-state, compounded mandrel material is cooled to a solidification temperature within the mold to form a solidified melt-out mandrel. The solidified melt-out mandrel is removed from the mold.

In another aspect, a method of producing a hollow composite article includes forming a composite-wrapped mandrel by wrapping an outer surface of a melt-out mandrel with a composite material, the outer surface of the melt-out mandrel defines an inner geometry of the hollow composite article. The melt-out mandrel is made up of a compounded mandrel material. The composite material is cured into a cured composite material by heating the composite-wrapped mandrel to a first temperature, wherein the first temperature is sufficient to cure the composite material. The melt-out mandrel is changed to a flowable state by heating the composite-wrapped mandrel to a second temperature, wherein the second temperature is greater than the first temperature. The flowable-state melt-out mandrel is removed from the cured composite material thereby creating a hollow composite article.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a plan perspective view of a melt-out mandrel in accordance with embodiments herein;

FIG. 2 is a plan perspective view of a composite article to be manufactured by the melt-out mandrel depicted in FIG. 1, in accordance with embodiments herein;

FIG. 3 is a schematic view of equipment and method steps used to manufacture the melt-out mandrel and the composite article in accordance with embodiments herein;

FIG. 4 is side elevation view of an injection molding machine used in some of the method steps of FIG. 3, in accordance with embodiments herein;

FIG. 5 is a perspective view of a compounding unit and an injection unit of the injection molding machine in FIG. 3, in accordance with embodiments herein;

FIG. 6 is a side elevation view of a clamping unit of the injection molding machine in FIG. 3, in accordance with embodiments herein;

FIG. 7 is a fragmentary perspective view of an injection mold within the clamping unit of the injection molding machine in FIG. 3, in accordance with embodiments herein;

FIG. 8 is a fragmentary perspective view of a composite-wrapped mandrel during one of the method steps of FIG. 3, in accordance with embodiments herein;

FIG. 9 is a top perspective view of a composite-wrapped mandrel within a cavity of a mold, in accordance with embodiments herein;

FIG. 10 is a flowchart of an exemplary method of producing a melt-out mandrel for defining an inner geometry of a composite article, in accordance with embodiments herein;

FIG. 11 is a flowchart of another exemplary method of producing a melt-out mandrel for defining an inner geometry of a composite article, in accordance with embodiments herein; and

FIG. 12 is a flowchart of a method of producing a hollow composite article in accordance with embodiments herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

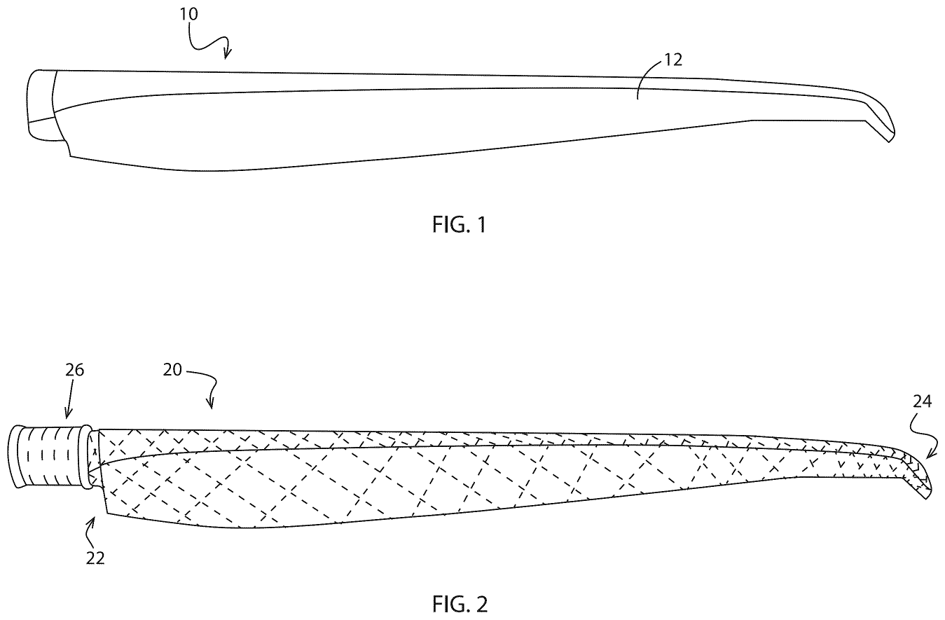

Turning to FIG. 1, a melt-out mandrel constructed in accordance with an embodiment of the invention is illustrated. The illustrated melt-out mandrel 10 is configured for a propeller blade application; however, any composite article featuring trapped geometry may be fabricated utilizing melt-out mandrel methodology. Composite parts with internal designs that are substantially hollow and also contain undercuts, negative draft angles, and trapped features may be referred to as “trapped geometry.” Composite parts with trapped geometries must be fabricated with mandrels that must either be disassembled or destroyed. These mandrels are also referred to as “fugitive” mandrels because they are held within the internal space of a molded composite part until they are disassembled or destroyed. The melt-out mandrel defines the internal geometry of the composite article. The features of the melt-out mandrel directly correspond to the internal features of the resultant composite article, as evidenced by the relationship between the melt-out mandrel depicted in FIG. 1 and the substantially hollow composite article shown in FIG. 2. An outer surface 12 of the melt-out mandrel forms the inner geometry of the hollow composite article 20, as depicted in FIG. 2.

Specifically, the finished composite article 20 in FIG. 2 is an example of a complex composite part that has been manufactured with the aid of a melt-out mandrel, such as the melt-out mandrel 10 of FIG. 1. To construct a composite article with the aid of a melt-out mandrel, the melt-out mandrel is molded to a net-shape that will define the internal geometry of the composite article, the melt-out mandrel is wrapped with a composite material, the composite material is cured around the melt-out mandrel at a first temperature, and once the composite article is cured, the melt-out mandrel is heated to a second, higher temperature sufficient to melt the mandrel material such that it flows out from the composite article. The interior space of the composite article 20 is defined by the melt-out mandrel 10, forming trapped geometry features 22, 24 of the composite article 20. Furthermore, in some embodiments, hardware 26 may be joined to the composite article prior to or after the removal of the melt-out mandrel.

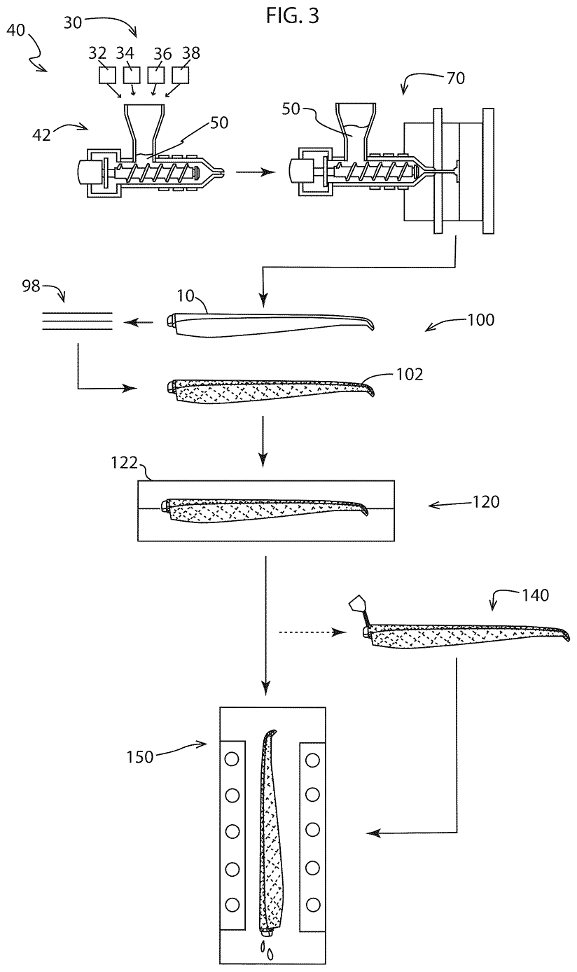

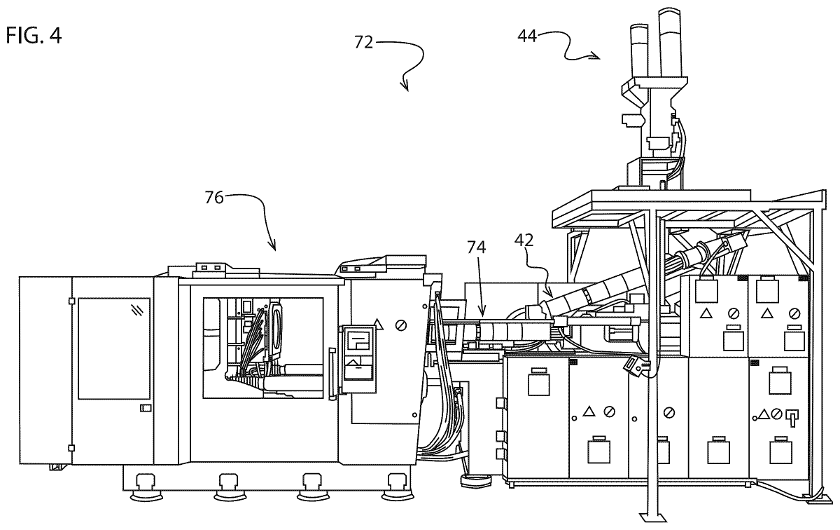

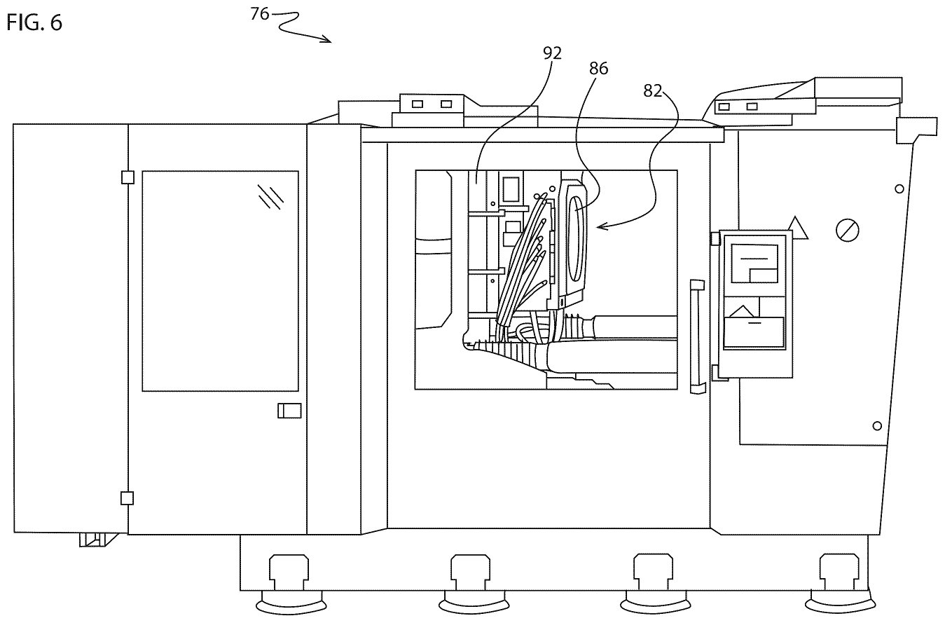

Referring next to FIG. 3, a schematic flow chart of a process used to manufacture the melt-out mandrel and the composite article is shown in accordance with an embodiment of the invention. During a compounding process 40, mandrel material constituents 30 are fed into a compounding unit 42. The constituents 30 are compounded within the compounding unit 42 where they are melted and homogenized to produce a compounded mandrel material 50. The compounded mandrel material 50 is transferred to an injection unit 74 of an injection molding machine 72. The injection unit 74 feeds into an injection mold 82 which is mounted within a clamping unit 76 of the injection molding machine 72, such as in FIGS. 4 and 6. The compounded mandrel material 50 is injected into the closed injection mold 82 to form the shape of the melt-out mandrel 10. Within the mold, the melt-out mandrel 10 cools and solidifies. After the melt-out mandrel 10 has solidified, it is removed from the injection mold 82. Although the resulting melt-out mandrel is described as being entirely made of melt-out material, note that in some alternative embodiments, the melt-out mandrel 10 is manufactured as a combination permanent/melt-out mandrel with removable permanent mandrel portions and melt-out mandrel portions. Permanent mandrel portions may be used to take up bulk space in shapes and configurations where such mandrels are easily extractable, while the melt-out mandrel portions may be utilized in trapped geometry portions of a hollow composite part to be formed therewith.

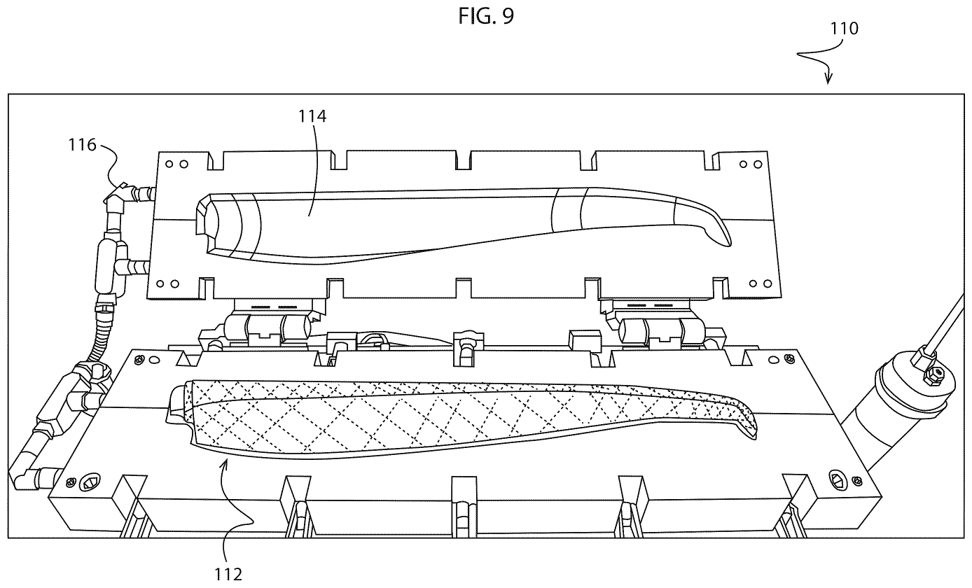

The melt-out mandrel 10 may be transferred to a different work cell or a different facility for the composite article manufacturing process. The melt-out mandrel 10 is wrapped with composite material 98, forming a composite-wrapped mandrel 102. The melt-out mandrel 10 defines the internal geometry of the composite article 20 and at least one composite molding surface 114 (as depicted in FIG. 9) defines an outer geometry of the composite article. In an exemplary embodiment of FIG. 3, the composite mold may be a two-sided mold 122 utilized at a composite molding step at 120. The composite-wrapped mandrel 102 is heated to a first temperature to cure the composite material. At step 140, the melt-out mandrel may remain within the cured composite article during trimming and/or drilling to support the composite article. Finally, the melt-out mandrel is heated to a second temperature, turning it into a flowable state such that it flows out of the composite article during the melt-out process depicted at step 150. The second temperature (melting temperature) for the mandrel is higher than the first temperature at which the composite material is cured. The melt-out mandrel maintains structural integrity during the cure cycle of the composite article. Although steps are depicted in various orders in FIG. 3, note that other orders may be utilized and/or some of the steps may be performed simultaneously without departing from the scope of the technology herein. Furthermore, in some embodiments one or more of the steps may be omitted and/or other steps may be added hereto without departing from the scope of the technology herein.

Turning now to FIG. 4, the injection molding machine 72 is depicted as incorporating a compounding unit 42 connected to the injection unit 74 of the injection molding machine 72. In an exemplary embodiment, the injection molding machine is a Krauss Maffei GX 1100 DCIM, manufactured by KraussMaffei based in Parsdorf, Germany, which employs direct compounding inline with the injection unit of the machine. The mandrel material constituents 30 may be precisely metered into the compounding unit 42 by a metering unit 44 mounted to the injection molding machine. The direct compounding unit 42 melts and compounds the constituents 30, creating the compounded mandrel material 50. The compounded mandrel material 50 remains in melt (a flowable state) as it is transferred into the injection unit 74.

The injection unit 72 injects the compounded mandrel material in a flowable state into the injection mold 82. The injection unit has a nozzle 68 that connects to a runner system within the injection mold 82. The runner system feeds into the gates which deliver material into the cavity 84 of the injection mold 82. During injection, the compounded mandrel material 50 fills the cavity 84 of the injection mold 82, forming the melt-out mandrel 10. Once the melt-out mandrel has sufficiently cooled and solidified within the cavity 84 of the injection mold 82, the melt-out mandrel 10 is ejected from injection mold. A robot may retrieve the melt-out mandrel from the clamping unit area (e.g., the clamping unit 76) of the injection molding machine. The melt-out mandrel may be transferred to a finishing operation for post-processing. Examples of finishing operations may include removing gates and runner systems that may still be attached to the melt-out mandrel.

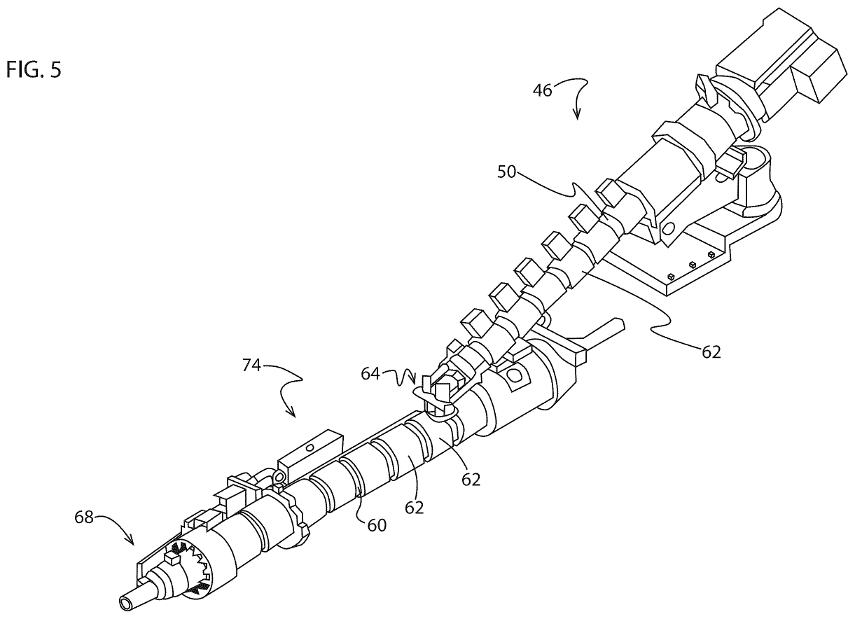

Referring to FIG. 5, a perspective view of an exemplary embodiment of an extruder 46 of a compounding unit 42 connected to the injection unit 74 of the injection molding machine 72 is shown. The extruder 46 combines the material constituents to make the compounded mandrel material. In some embodiments, the extruder has a single screw within the extruder barrel 50 to melt the constituents and compound them together into a homogenous material. The screw also conveys the material from the rear portion of the barrel to the front portion of the extruder to a connector 64 where the material is fed into the injection unit 74. Heater bands 62 surround the barrels of the extruder 46 and the injection unit 74 to aide in the heating the material. In one or more embodiments, the injection unit has an injection barrel 60 with a reciprocating screw inside of the barrel. The screw carries the melted material to the nozzle end of the barrel, creating a shot of the compounded mandrel material. During the injection portion of the injection molding cycle, the screw rapidly moves forward toward the nozzle 68 to inject the shot of compounded mandrel material into the injection mold 82.

In some embodiments, direct compounding occurs in a continuous, uninterrupted sequence wherein the compounded melted material is directly transferred into the injection unit of the injection molding machine. Direct compounding mitigates polymer chain degradation while simultaneously reducing energy consumption and associated carbon dioxide emissions by eliminating cooling and reheating cycles between compounding and molding. Although direct compounding is the preferred embodiment of the present disclosure, other methods of introducing the compounded mandrel material into the injection unit are possible. For example, the material constituents may be combined in a compounding process not in line with the injection molding machine, extruded into pellets, and then loaded into the injection unit of the injection molding machine. Introducing the compounded mandrel material in pellet form into the injection molding process is a solution for a manufacturer that does not have direct compounding capabilities.

The compounded melt-out mandrel material is made from a compounded thermoplastic material. In one or more embodiments, the compounded thermoplastic material may include a thermoplastic material 34, a filler 36 and an additive 38. For example, the compounded thermoplastic material may include a polyethylene wax with a ceramic microsphere filler and heat stabilization or antioxidant additive. In one or more embodiments, the compounded thermoplastic material may include a wax material, which may be a foundry wax such as paraffin, stearin, ceresin, runner wax, or Fischer-Tropsch wax. Other types of wax-like materials may be included in the compounded thermoplastic material such as fatty acid derivatives, polymeric waxes, non-polymeric waxes, or other organic phase change materials. Higher molecular weight thermoplastic materials may also be compounded into the material, which may comprise polymers such as polypropylene, polyethylene, combinations thereof, or other suitable thermoplastic polymers not limited to those listed herein. The compounded thermoplastic material may include multiple types of thermoplastic polymers or non-polymers combined in proportions that selectively optimize the melting point and flow characteristics during both the injection and subsequent mandrel melt-out process. At least one filler may be used to provide dimensional stability and to improve the desired properties of the compounded mandrel material. Examples of fillers include ceramic microspheres, glass microspheres, or other fillers. Additives may include antioxidants and stabilizers such as phenolic antioxidants, phosphites, thiosynergists, thioethers, hydroxylamine stabilizers, amine stabilizers, and hydroxylamines, or flow enhancers. The compounded thermoplastic material may also incorporate solid, liquid, or gas foaming agents to lighten the mandrel material and reduce the thermal energy requirement for processing. The compounded mandrel material may be configured to provide a distinct melting point that is above the cure temperature of the composite material. The compounded mandrel material is configured to have thermal expansion and dimensional stability characteristics suitable for the composites molding process, which often involves elevated temperatures and pressure, especially when resin transfer molding or autoclave processing is employed to mold the composite article. Furthermore, the compounded mandrel material may incorporate reground melt-out mandrel material from previous manufacturing cycles.

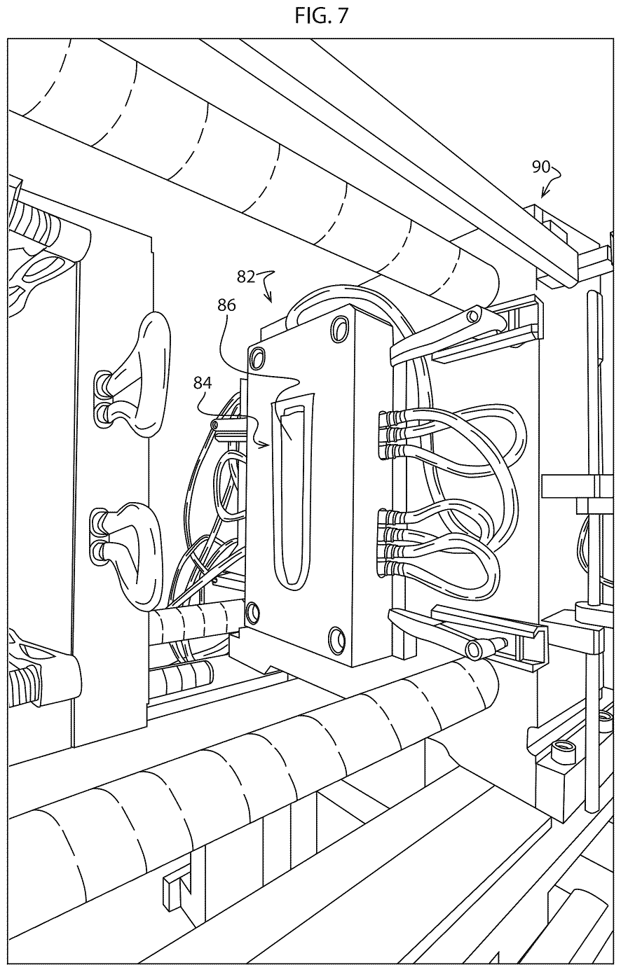

The clamping unit 76 of the injection molding machine 72 is shown in FIGS. 6 and 7. The injection mold 82 is clamped to platens 90, 92 of the injection molding machine 72. The injection mold is a multi-part mold whereby one half of the mold is mounted to the stationary platen 90 which is adjacent to the injection unit 74. The other half of the mold is mounted on the moving platen 92. The moving platen 92 is actuated by the injection molding machine to open and close the injection mold 82. Actuation of the moving platen 92 provides the clamping force necessary to withstand the injection pressure of the material being injected into the cavity of the injection mold. The injection mold has molding surfaces 86 that form a cavity 84 when the injection mold 82 is closed. The compounded mandrel material is injected into the injection mold and fills the cavity, forming the desired geometry of the melt-out mandrel 10.

The injection molding process of molding a melt-out mandrel creates a fully formed mandrel that does not require any machining or additional shaping prior to being wrapped with composites. Nevertheless, in some embodiments, the melt-out mandrel may additionally be machinable in nature, permitting secondary machining of features that are not readily moldable when required. For example, starting with a near-net molding, the melt-out mandrel may be machines to a final configuration when prototyping. The overall injection molding process from injection to the removal of the melt-out mandrel may take than less than 5 minutes to complete. In the example of FIG. 7, the injection mold is a two-part, single cavity mold, but other types of multi-part molds may be used to mold the melt-out mandrel. It is within the scope of the present disclosure that multiple melt-out mandrels may be molded individually and assembled to form the internal geometry of a composite article. Using multiple individual melt-out mandrels may be beneficial for creating composite articles with internal bays of closed structure. In one or more embodiments, the melt-out mandrels may have their mass reduced by adding a blowing agent or direct injection of a gas. This would have the benefit of reduced weight, cost, extraction energy cost, and the like. This may require employing an additive in the injection process that is a solid, liquid or gas foaming agent.

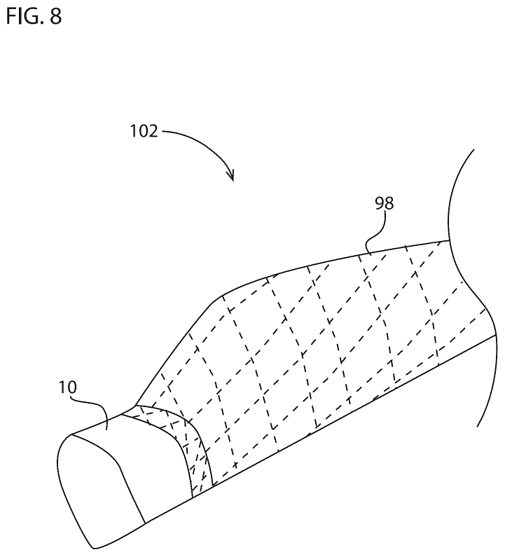

Referring to FIG. 8, a portion of the composite-wrapped melt-out mandrel 102 is shown according to an exemplary embodiment of the present disclosure. The melt-out mandrel 102 is wrapped with composite material 98 prior to composite molding. The composite material may be a prepreg, dry carbon fiber, fabric, random mat, braids or dry fiber with a thermoplastic veil. The composite material may comprise many layers of composite material and combinations of different types of material. For example, one layer of the composite article may incorporate a carbon braid and other layers may comprise other forms of composite material such as fabric layers. The melt-out mandrel may serve as a mandrel for a braiding or an automated fiber application process where the fiber is wrapped around the melt-out mandrel prior to the composite molding process. The resin system used in the composite material may be a thermoset or a thermoplastic. Thermoset resins used in the composite material may include epoxy resins, bismaleimides, cyanate esters, phenolics, polyimides, benzoxazines, phthalonitriles, polyesters, and vinyl esters. For certain composite materials, including prepregs, it is possible to heat set the composite material such that it conforms to the melt-out mandrel and takes the shape of the mandrel prior to the cure cycle.

The composite-wrapped melt-out mandrel 102 is placed on a composites mold 122 containing at least one molding surface. During the curing of the composite material, the composite material is compressed against the melt-out mandrel. The composite mold may be a single sided mold that is used in conjunction with a pressure application apparatus such as vacuum bag or a conformable diaphragm. It should be noted that the melt-out mandrel may be wrapped prior to being placed in the composite mold 122, however it is within the scope of the present disclosure that composite material 98 may be placed in the composite mold 98 before positioning the melt-out mandrel in the mold and wrapping it with the composite material 98.

Together, the mold and the melt-out mandrel may compress the composite material during the cure cycle because the melt-out mandrel expands slightly at the elevated cure temperature. In one or more embodiments, the melt-out mandrel is lightweight, having a specific gravity of 0.95 or lower, making handling the melt-out mandrel easy for technicians and robots. However, certain highly spherical, low CTE fillers, such as fused silica, may allow for higher density without departing from the scope of the technology described herein. Increasing the proportion of fillers used in the compounded mandrel material lowers the specific gravity and lowers the coefficient of thermal expansion of the compounded mandrel material. In one or more embodiments, the melt-out mandrel is inherently self-releasing, eliminating the need for mold releasing agent on the outer surface of the mandrel prior to composite material application. However, in one or more other embodiments, a secondary mold release may be employed if needed, depending on the polymers being used, if such alternative polymers are not inherently self-releasing. Additionally, the melt-out mandrel composition described herein may, in some embodiments, not contaminate the composite material, addressing a common concern in composites manufacturing.

In a preferred embodiment, the composite molding process may be resin transfer molding (RTM) and the mold may be a resin transfer mold 110, as depicted in FIG. 9, that fully surrounds the composite-wrapped melt-out mandrel 102. In the exemplary embodiment in FIG. 9, the melt-out mandrel 10 has been wrapped in a type of dry fiber fabric composite material 98. The composite-wrapped mandrel 102 is positioned within a composite mold cavity 112 of the resin transfer mold 110. The mold cavity has at the least one molding surface 114 to shape the external geometry of the composite-wrapped mandrel. The mold 110 is closed and heated to an optimal processing temperature for injecting the resin. For some types of resin, the optimal RTM injection temperature is around 110 °F. However, other injection temperatures may be used without departing from the scope of the techniques described herein.

Hot oil plumbing 116 facilitates the circulation of heated oil through internal channels of the resin transfer mold 110. Water may alternatively be used in such a circulation system or plumbing without departing from the scope of the technology described herein. The resin transfer mold 110 is configured to receive resin which is injected into the mold cavity 112 and permeates the dry fiber. During injection, the resin fills the spaces between the fibers and the layers of the composite material. The melt-out mandrel 10 with an inherently low surface-energy finish and a thermally insulating quality, enhances resin flow through the fibers during RTM injection. After the fibers are fully permeated with resin, the composite mold temperature is raised to a curing temperature that is sufficient for curing the composite material. Curing temperatures sufficient for curing the composite material vary based on various characteristics of the composite material and associated resin used. The curing temperature may be within a range, depending upon the composite material utilized, of 100 °F-350 °F. However, other curing temperature ranges may be used without departing from the scope of the technology herein.

As the composite material 98 is exposed to the curing temperature over the course of the cure cycle, it transitions into a cured composite material. The melt-out mandrel 10 may be configured to expand slightly at the elevated cure temperature in some embodiments, but is not configured to soften at the curing temperature of the composite material 98. The expansion of the melt-out mandrel 10 during the cure process may advantageously consolidate the composite material 98 by applying pressure to the composite material 98 which is interposed between the melt-out mandrel 10 and the molding surface 114. Although curing the composite article may occur within the resin transfer mold, other options are available for heating the composite material to a curing temperature to facilitate curing. Examples of heating devices include ovens, autoclaves and heated presses. The term “cure” should be understood to mean that the resin is sufficiently solidified to be able to be handled, and the degree of cure or consolidation of the resin may vary. A post-processing thermal treatment may be implemented to achieve complete curing of the composite material, such as a free-standing post-cure cycle, wherein the composite article undergoes an additional heat cycle after removal of the melt-out mandrel to ensure optimal cross-linking of the resin.

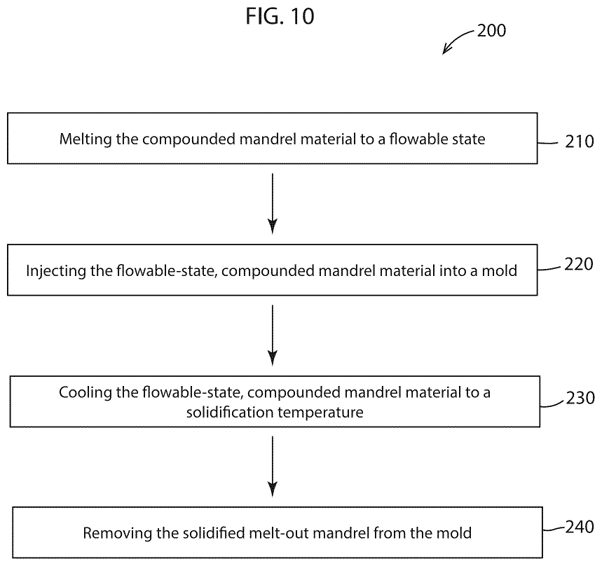

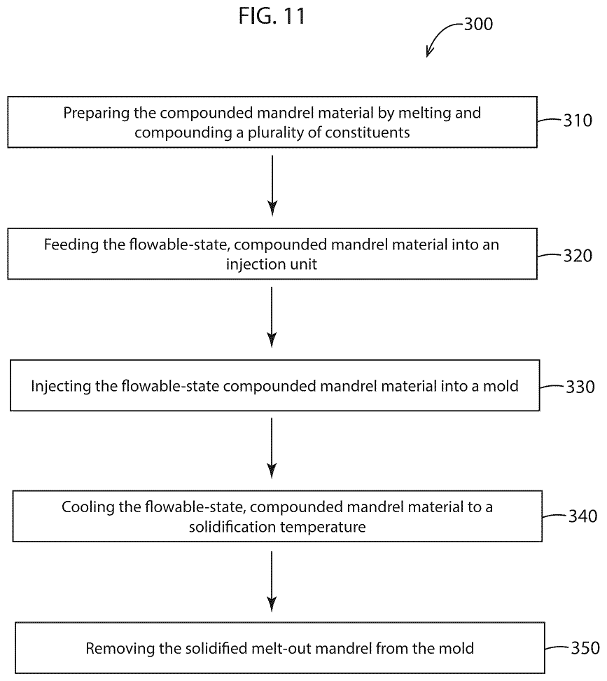

The flow charts of FIGS. 10 and 11 depict exemplary methods 200 and 300 for producing a melt-out mandrel (e.g., the melt-out mandrel 10) for defining the inner geometry of a composite article in more detail. In some embodiments, various steps may be omitted, or steps may occur out of the order depicted in FIGS. 10 and 11 without departing from the scope of the technology as described herein. For example, two blocks shown in succession in FIGS. 10 and 11 may in fact be executed substantially concurrently, or blocks may sometimes be executed in the reverse order depending upon the functionality involved.

The method 200 may include a step of melting a compounded mandrel material such that the compounded mandrel material is in a flowable state, as depicted in block 210. Specifically, the compounded mandrel material is prepared by melting and compounding a compounded thermoplastic material as described above. Additionally or alternatively, it is within the scope of the disclosure that the compounding of the mandrel material may occur remotely from the injection molding process, whereby the material is compounded and formed into pellets by a stand-alone extrusion process. The compounded mandrel material pellets may be introduced into the injection unit of an injection molding machine (e.g., the injection molding machine 72), whereupon they are melted and subsequently injected into the injection mold to form the melt-out mandrel.

The method may further include a step of injecting the flowable-state compounded mandrel material into a mold having a shape that defines an inner geometry of the composite article being formed, as depicted in block 220, and cooling the compounded mandrel material to a solidification temperature within the mold, as depicted in block 230, thereby forming a solidified melt-out mandrel. The solidification temperature varies slightly depending upon the specific formulation of the compounded melt-out mandrel material, but generally falls within the range suitable for rapid production cycles (under 5 minutes per mandrel).

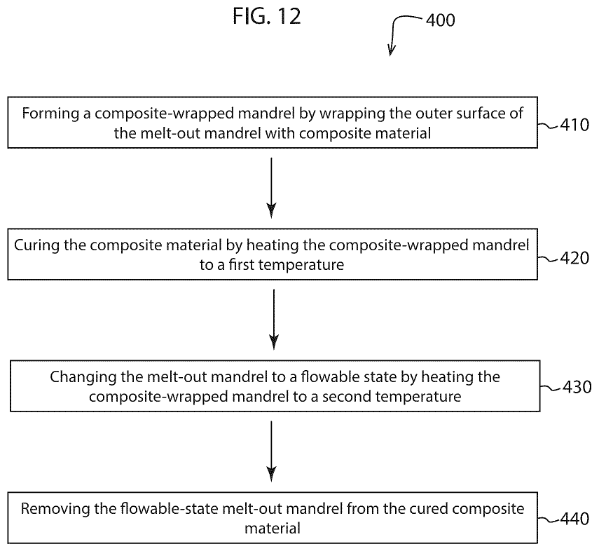

The method 200 also includes a step of opening the injection mold and removing the solidified melt-out mandrel from the injection mold, as depicted in block 240. The injection mold may be a multi-part mold where one part of the mold is mounted to the stationary platen of the injection molding machine and another part of the mold is mounted to the moving platen whereby the moving platen opens the injection mold. After the mold has opened, ejector pins may force the melt-out mandrel from the cavity of the injection mold. A robot or a technician may move the melt-out mandrel from the injection molding machine clamping unit area to a second location or work cell designed for the composite wrapping process. That is, in some embodiments, the solidified melt-out mandrel may then be used for the method steps depicted in FIG. 12. It should be noted that melt-out mandrel molding, mandrel wrapping, composite curing, and mandrel extraction from the composite article may be performed across multiple locations, within dedicated work cells, or within one integrated work cell, contingent upon the specific capabilities and infrastructure of the production facility.

The method 300 depicts another embodiment of the method 200. The method 300 of FIG. 11 may include preparing the compounded mandrel material by melting and compounding of a plurality of constituents, as depicted in block 310. Specifically, the melting and compounding is achieved or performed at the same time with an extruder feeding directly into the injection molding machine. Furthermore, the method 300 may include feeding the flowable-state, compounded mandrel material into an injection unit, as depicted in block 320, and injecting the flowable-state compounded mandrel material from the injection unit into a mold, as depicted in block 330. The method 300 additionally includes cooling the flowable-state, compounded mandrel material to a solidification temperature, as depicted in block 340, and removing the solidified melt-out mandrel from the mold, as depicted in block 350. In some embodiments, the solidified melt-out mandrel may then be used for the method steps depicted in FIG. 12. In one example embodiment, the extruder feeds directly into the injection molding machine, then a mold sprue valve is opened to allow the extruder to fill the mold substantially. During this process, the extruder feeds melted material into the injection unit with the injection screw in recovery mode while the shutoff valve of the injection unit is open to allow the material to flow into the mold. Next in this example embodiment, the injection screw is plunged to provide a final fill of the mold cavity and exert molding pressure to the material in the mold cavity. These example embodiment steps may be used where the mold cavity size exceeds the shot size capacity of the injector.

The flow chart of FIG. 12 depicts an exemplary method 400 for producing a hollow composite article in more detail. In some embodiments, various steps may be omitted, or steps may occur out of the order depicted in FIG. 12 without departing from the scope of the technology as described herein. For example, two blocks shown in succession in FIG. 12 may in fact be executed substantially concurrently, or blocks may sometimes be executed in the reverse order depending upon the functionality involved.

The method 400 may include a step of forming a composite-wrapped mandrel by wrapping an outer surface of the melt-out mandrel with composite material, as depicted in block 410. The outer surface of the melt-out mandrel defines the inner geometry of the hollow composite article. The method 400 may also include a step of curing the composite material by heating the composite-wrapped mandrel to a first temperature sufficient to cure the composite material, as depicted in block 420. The first temperature may be within a range, depending upon the composite material utilized, of 230 °F-350 °F. With a higher coefficient of thermal expansion, the melt-out mandrel expands and applies compaction to the composite material during the cure cycle. Using the melt-out mandrel within an RTM process can reduce resin content and void content in the composite material, or may provide the necessary compaction pressure for a prepreg composite material process. The melt-out mandrel may have a sharp melting point and a low melt viscosity. For example, in some embodiments, the melt-out mandrel transitions from a solid to a flowable state within a processing range of 20 °F-50 °F. The mandrel has a defined melting point that may fall within a range of 120 °F-240 °F or 240 °F-350 °F, depending upon the formulation of the material constituents. In some embodiments, the melt-out mandrel maintains sufficient rigidity to support the composite material during the cure cycle, which may last for 30 minutes or more depending on the composite material system and the composite article size.

The method also includes a step of changing the melt-out mandrel to a flowable state by heating the melt-out mandrel to a second temperature that is higher than the cure temperature of the composite material, as depicted in block 430. The second temperature may be in a range of 270 °F-400 °F depending upon the formulation of the compounded mandrel material. In some embodiments, the second temperature is approximately 20 °F above the cure temperature of the composite material. At the elevated temperature, the melt-out mandrel is changed to a flowable state. The method 400 may further include removing the flowable-state melt-out mandrel from the cured composite material, as depicted in block 440, leaving the hollow composite article with the internal features that were defined by the melt-out mandrel. The melting of the melt-out mandrel may take place within an oven, autoclave, heated oil bath, or an infrared or induction heating device. The melt-out process may be accelerated by applying vacuum to extract the melted mandrel material or utilizing gravity-assisted drainage through exit ports. Additional methods of removal may include centrifugal extraction or vibrational assistance to aide in extracting the melted mandrel material through complex internal geometries.

In the flowable state, the melt-out mandrel material has low viscosity and can drain from small openings within the composite article, for example, the melted mandrel material easily flows out of holes with a 0.25″ diameter. The melt-out mandrel material may be reused and is environmentally safe for disposal. The hollow composite article undergoes a sequential cleaning process consisting of a mineral-oil based solvent treatment, followed by an alkaline wash procedure and thorough water rinsing to ensure complete removal of all melt-out mandrel residue.

Disclosed herein is a method and system for producing a melt-out mandrel and using the melt-out mandrel to manufacture a composite article. The lightweight, low-cost, recyclable melt-out mandrel can be molded to a net-shape to form the hollow internal structure of an integrated composite article. The mandrel material can be compounded and injection molded using conventional thermoplastic processing equipment, allowing for complex geometries with tight dimensional tolerances to be achieved cost-effectively. This moldability enables the creation of precise internal features that directly translate to the final composite part, including integrated stiffening elements. The ability to rapidly produce these net-shape mandrels significantly reduces tooling costs and lead times compared to traditional composite manufacturing approaches, while the recyclability of the mandrel material after melt-out further enhances the sustainability of the overall manufacturing process.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A method of producing a melt-out mandrel for defining an inner geometry of a composite article, the method comprising:
melting a compounded mandrel material to a flowable state, the compounded mandrel material comprising a compounded thermoplastic material;
injecting the flowable-state, compounded mandrel material into a mold having a shape that defines the inner geometry of the composite article;
cooling the flowable-state, compounded mandrel material to a solidification temperature within the mold, thereby forming a solidified melt-out mandrel via the solidification of the compounded mandrel material; and
removing the solidified melt-out mandrel from the mold.

2. The method of claim 1, wherein the melting further comprises preparing the compounded mandrel material by both melting and compounding the compounded thermoplastic material with an extruder.

3. The method of claim 2, wherein the method further comprises:
feeding the flowable-state, compounded mandrel material directly into an injection unit of an injection molding machine configured to inject the flowable-state, compounded mandrel into the mold.

4. The method of claim 1, wherein the mold is a multi-part mold and removing the solidified melt-out mandrel from the multi-part mold comprises opening the multi-part mold with a moving platen of an injection molding machine to remove the solidified melt-out mandrel.

5. The method of claim 1, further comprising wrapping composite material around the solidified melt-out mandrel and curing the composite material wrapped around the solidified melt-out mandrel into the composite article, wherein the compounded mandrel material has a higher melting point than a curing point of the composite material.

6. The method of claim 5, further comprising melting the solidified melt-out mandrel after curing the composite material into the composite article.

7. The method of claim 1, further comprising feeding the compounded mandrel material into an injection unit in either a pellet form or a melt form through a connection to a compounding unit, wherein the injection unit is configured to inject the flowable-state compounded mandrel material into the mold.

8. The method of claim 1, wherein the compounded thermoplastic material comprises a thermoplastic material, a filler, and an additive.

9.-20. (canceled)
